(19) United States
(12) Patent Application Publication
(10) Pub. No.: US 2025/0258074 A1
(43) Pub. Date: Aug. 14, 2025

(54) DEFECT DETERMINATION APPARATUS, DEFECT CLASSIFICATION APPARATUS, AND DEFECT DETERMINATION METHOD

(71) Applicant: Panasonic Automotive Systems Co., Ltd., Kanagawa (JP)

(72) Inventors: Nobuaki UENO, Tokyo (JP); Hirohito MUKAI, Tokyo (JP); Ikuya WAKAMORI, Kanagawa (JP); Osamu SHIBATA, Hyogo (JP); Takanori KIKUCHI, Kanagawa (JP)

(21) Appl. No.: 19/047,222

(22) Filed: Feb. 6, 2025

(30) Foreign Application Priority Data
Feb. 9, 2024 (JP) 2024-018574

(51) Int. Cl. G01N 3/22

(52) U.S. Cl. CPC G01N 3/22; G01N 2203/0021; G01N 2203/0062; G01N 2203/0218; G01N 2203/0262; G01N 2203/0676

(57) ABSTRACT

A defect determination apparatus according to an aspect of the present disclosure includes: a physical quantity acquisition circuitry which, in operation, acquires a target physical quantity, the target physical quantity being a physical quantity generated in a power source during a new screw tightening; a model acquisition circuitry which, in operation, acquires a first trained model obtained through unsupervised learning of a physical quantity generated in the power source during a past screw tightening that has been normally completed; and a determination circuitry which, in operation, determines whether the new screw tightening has been normally completed by applying the target physical quantity to the first trained model.

### TECHNICAL FIELD

The present disclosure relates to a defect determination apparatus, a defect classification apparatus, a model generation apparatus, a defect determination method, a defect classification method, a model generation method, a trained model, and a recording medium.

### BACKGROUND ART

In an existing automatic screw tightening apparatus that performs screw tightening automatically, a technology is known that automatically determines a defect in screw tightening through threshold determination using physical quantities such as torque and rotation speed transmitted from a motor to a driver.

For example, PTL 1 discloses a technique for estimating the axial force of a screw generated by screw tightening, and performing a defect determination by comparing the estimated axial force with a threshold value. The technology disclosed in PTL 1 can detect a defective screw thread in which the screw thread is crushed, and a bottoming in which the screw tip comes into contact with the bottom surface of the screw hole before the seat surface of the screw head comes into contact with the fastening target. However, it is difficult to detect foreign object biting, in which a screw is fastened to a fastening target with dust or the like in between because the same axial force as that in normal screw tightening is generated.

Further, for example, PTL 2 discloses a technique for performing a defect determination by comparing with a threshold value a change amount in the axial direction position of a driver in the main tightening step from the time of temporary seating. The technique disclosed in PTL 2 is capable of detecting the above-described bottoming and foreign object biting. However, it is difficult to detect screw floating where the screw is obliquely inserted to the screw hole and fastened to the fastening target, because the change amount in the axial direction of the driver is the same as that in normal screw tightening.

Further, for example, PTL 3 discloses a technique for performing a defect determination by extracting a feature quantity from a waveform or rotation speed torque and comparing the feature quantity with a threshold value. Further, PTL 3 discloses selecting a plurality of feature quantities that contributes to accuracy improvement, extracting these selected feature quantities from waveforms of torque or rotation speed, and integrating them into a single numerical index. Further, PTL 3 discloses that, in order to reduce the selection load of a plurality of feature quantities that contributes to the accuracy improvement, a feature quantity that has a high correlation with a conforming product and a non-conforming product in a screw tightening state and has a small variation is selected through machine learning. The technique disclosed in PTL 3 is capable of detecting the above-described defective screw thread and foreign object biting. However, the technique disclosed in PTL 3 provides a dedicated threshold value for each type of defect, and as such it is difficult to detect defects such as screw floating for which no threshold value is set.

### CITATION LIST

### Patent Literature

PTL 1
Japanese Patent No. 7375684
PTL2
Japanese Patent No. 7070467
PTL 3
Japanese Patent No. 7186905

### SUMMARY OF INVENTION

### Technical Problem

All of the above-described existing technology are based on a design concept of detecting defects of given types. For this reason, in any of the above-described known techniques, it is difficult to deal with defects that are not included in the design concept (defects other than given types). For this reason, in any of the above-described known techniques, it is difficult to determine whether the screw tightening has been normally completed, regardless of whether or not the defect is included in the design concept, e.g., regardless of the type of defect.

In view of the above circumstances, an object of the present disclosure is to provide a defect determination apparatus, a defect classification apparatus, and a defect determination method, each of which is capable of determining whether the screw tightening has been normally completed, regardless of the type of defect.

### Solution to Problem

A defect determination apparatus according to an aspect of the present disclosure includes: a physical quantity acquisition circuitry which, in operation, acquires a target physical quantity, the target physical quantity being a physical quantity generated in a power source during a new screw tightening; a model acquisition circuitry which, in operation, acquires a first trained model obtained through unsupervised learning of a physical quantity generated in the power source during a past screw tightening that has been normally completed; and a determination circuitry which, in operation, determines whether the new screw tightening has been normally completed by applying the target physical quantity to the first trained model.

A defect classification apparatus according to an aspect of the present disclosure includes: a physical quantity acquisition circuitry which, in operation, acquires a target physical quantity, the target physical quantity being a physical quantity generated in a power source during a new screw tightening; a model acquisition circuitry which, in operation, acquires a trained model that has been trained with a physical quantity generated in the power source during a past screw tightening in which an abnormality has occurred as an input and with a defective classification result of screw tightening as an output; and a classify circuitry which, in operation, classifies a defect in the new screw tightening by applying the target physical quantity to the trained model.

A defect determination method according to an aspect of the present disclosure includes: physical quantity acquiring, by a physical quantity acquisition circuitry, a target physical quantity, the target physical quantity being a physical quantity generated in a power source during a new screw tightening; first trained model acquiring, by a model acquisition circuitry, a first trained model obtained through unsupervised learning of a physical quantity generated in the power source during a past screw tightening that has been normally completed; and determining, by a determination circuitry, whether the new screw tightening has been normally completed by applying the target physical quantity to the first trained model.

### Advantageous Effects of Invention

According to the present disclosure, it is possible to provide a defect determination apparatus, a defect classification apparatus, and a defect determination method, each of which is capable of determining whether the screw tightening has been normally completed, regardless of the type of defect.

### BRIEF DESCRIPTION OF DRAWINGS

FIG. 1 is a schematic diagram illustrating an example of configuration of a screw tightening apparatus according to Embodiment 1;

FIG. 2 is a diagram illustrating an example of a torque waveform generated in a motor from the start to the end of the screw tightening by the screw tightening apparatus according to Embodiment 1;

FIG. 3 is a diagram illustrating a comparison example between a torque waveform of a normal system by the screw tightening apparatus according to Embodiment 1 and a torque waveform of an abnormal system;

FIG. 4 is a block diagram illustrating an example of a hardware configuration of the defect determination apparatus according to Embodiment 1;

FIG. 5 is a block diagram illustrating an example of a functional configuration of the defect determination apparatus according to Embodiment 1;

FIG. 6 is an explanatory diagram illustrating an example of an unsupervised learning method by the learner according to Embodiment 1;

FIG. 7 is an explanatory diagram illustrating an example of an unsupervised learning method by the learner according to Embodiment 1;

FIG. 8 is an explanatory diagram illustrating an example of a defect determination method using a first trained model by the determiner according to Embodiment 1;

FIG. 9 is a flowchart illustrating an example of a screw tightening process by the screw tightening apparatus according to Embodiment 1;

FIG. 10 is a flowchart illustrating an example of a learning process by the defect determination apparatus according to Embodiment 1;

FIG. 11 is a flowchart illustrating an example of a defect determination process by the defect determination apparatus according to Embodiment 1;

FIG. 12 is a block diagram illustrating an example of a functional configuration of a defect determination apparatus according to Embodiment 2;

FIG. 13 is an explanatory diagram illustrating an example of a learning method for a second trained model by the learner according to Embodiment 2;

FIG. 14 is a flowchart illustrating an example of a defect classification process by the defect determination apparatus according to Embodiment 2;

FIG. 15 is a block diagram illustrating an example of a functional configuration of a defect determination apparatus according to Embodiment 3;

FIG. 16 is an explanatory diagram illustrating an example of a pre-processing method for a target physical quantity by a pre-processor according to Embodiment 3;

FIG. 17 is a flowchart illustrating an example of a pre-preparation process for performing pre-processing by the defect determination apparatus according to Embodiment 3; and

FIG. 18 is a flowchart illustrating an example of the pre-processing by the defect determination apparatus according to Embodiment 3.

### DESCRIPTION OF EMBODIMENTS

Hereinafter, embodiments of the present disclosure (hereinafter, simply referred to as “the present embodiment”) will be described in detail with reference to the drawings. Note that the present disclosure is not limited to the following embodiments. Further, the following embodiments and modification examples can be combined as appropriate.

### Embodiment 1

First, an outline of the screw tightening apparatus will be described.

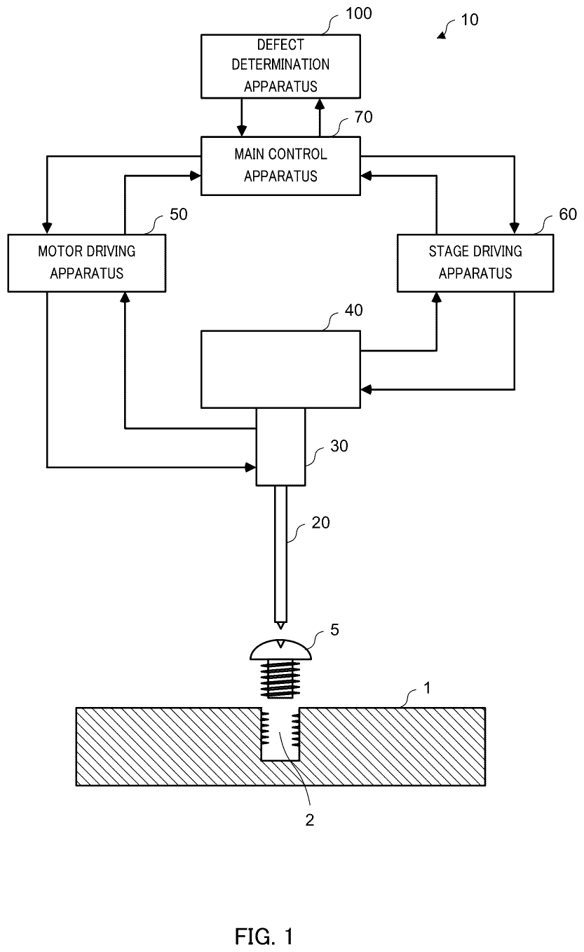

FIG. 1 is a schematic diagram illustrating an example of configuration of screw tightening apparatus 10 according to Embodiment 1. Screw tightening apparatus 10 is an apparatus that automatically performs screw tightening of screw 5 into screw hole 2 formed in work 1. Note that screw hole 2 corresponds to a female screw, and screw 5 corresponds to a male screw.

As illustrated in FIG. 1, screw tightening apparatus 10 includes driver bit 20, motor 30, stage 40, motor driving apparatus 50, stage driving apparatus 60, main control apparatus 70, and defect determination apparatus 100.

Driver bit 20 is a rotary tool for tightening screw 5 to screw hole 2. Driver bit 20 is attached to a rotation shaft (not illustrated) of motor 30, and rotates around the axis of driver bit 20 in accordance with the rotation of the rotation shaft. Driver bit 20 rotates around the axis with screw 5 attracted and held at the distal end, thereby transmitting the torque generated in motor 30 to screw 5, and fastening screw 5 to screw hole 2.

Motor 30 is a power source for screw tightening. Motor 30 may be, for example, a servo motor, but is not limited thereto. Motor 30 generates torque for fastening screw 5 to screw hole 2 by rotationally driving the rotation shaft in accordance with the drive signal output from motor driving apparatus 50. The drive signal may be, for example, a pulse width modulation (PWM) signal, but is not limited thereto. Further, motor 30 includes an encoder (not illustrated) that detects the torque or the rotation angle of the rotation shaft of motor 30 as an analog value and outputs the detected analog value to motor driving apparatus 50 as a feedback signal.

Stage 40 is a stage that is movable in the up-down, left-right, and depth directions, and is connected with motor 30 and driver bit 20 via motor 30. Stage 40 moves in accordance with the drive signal output from stage driving apparatus 60, thereby moving driver bit 20 to the desired position. Note that stage 40 includes a motor (not illustrated), and moves by rotationally driving the motor in accordance with a drive signal output from stage driving apparatus 60. Further, a motor (not illustrated) of stage 40 includes an encoder (not illustrated), and outputs a detection result of the encoder to stage driving apparatus 60 as a feedback signal. Embodiment 1 describes a case where stage 40 is movable in three-axis directions of up-down, left-right, and depth directions as an example, but this is not limitative. For example, stage 40 may be a stage that is movable in one axis direction in the up-down direction as long as work 1 is movable in the left-right and depth directions.

Motor driving apparatus 50 rotationally drives the rotation shaft of motor 30. Motor driving apparatus 50 includes, for example, a drive circuit such as a motor driver or a motor amplifier, but is not limited thereto. Motor driving apparatus 50 receives a motor control signal indicating the rotation angle, the rotation speed, the torque, and the like of motor 30 from main control apparatus 70. Motor driving apparatus 50 generates a drive signal that causes the rotation shaft of motor 30 to be rotationally driven with the control content indicated by the received motor control signal, and outputs the drive signal to motor 30.

Further, motor driving apparatus 50 receives the feedback signal described above from motor 30. Motor driving apparatus 50 generates a torque waveform actually generated in motor 30 and a waveform of the actual rotation speed of motor 30 based on the received feedback signal, and transmits the waveforms to main control apparatus 70. For example, motor driving apparatus 50 generates waveform data by sampling the received feedback signal at a fixed sample interval (for example, 2 ms) and quantizing the sampled feedback signal.

Stage driving apparatus 60 moves stage 40. Stage driving apparatus 60 includes, for example, a drive circuit such as a motor driver or a motor amplifier, but is not limited thereto. Stage driving apparatus 60 receives a stage control signal indicating the movement position of stage 40 from main control apparatus 70, generates a drive signal to move stage 40 to the indicated movement position, and outputs the drive signal to stage 40. Further, stage driving apparatus 60 receives the feedback signal described above from stage 40 and transmits the feedback signal to main control apparatus 70.

Main control apparatus 70 performs overall control of screw tightening apparatus 10. Main control apparatus 70 may be realized by, for example, a Programmable Logic Controller (PLC) or may be realized as software using a general-purpose processor or the like. Main control apparatus 70 generates the motor control signal and the stage control signal described above in accordance with a control flow registered in advance. Main control apparatus 70 controls the screw tightening by driver bit 20 by outputting the generated motor control signal to motor driving apparatus 50. Further, main control apparatus 70 controls the movement of driver bit 20 by outputting the generated stage control signal to stage driving apparatus 60. Main control apparatus 70 automates the screw tightening with screw tightening apparatus 10 by controlling driver bit 20 in this manner.

Further, main control apparatus 70 outputs to defect determination apparatus 100 data of the waveform of the rotation speed and the waveform of the torque of motor 30 that are received from motor driving apparatus 50, and receives a defect determination result using the data of these waveforms from defect determination apparatus 100.

Defect determination apparatus 100 determines whether the screw tightening with screw tightening apparatus 10 has been normally completed, regardless of the type of defect. For example, defect determination apparatus 100 may be realized as software using a general-purpose processor or the like, or may be realized by a PLC. Further, the defect determination apparatus 100 may be realized as the same apparatus as the main control apparatus 70 or may be realized as a different apparatus from the main control apparatus 70.

Using at least one of the waveforms of the torque and rotation speed of motor 30 received from main control apparatus 70, defect determination apparatus 100 determines whether the screw tightening with screw tightening apparatus 10 has been normally completed with no difference from the features of normal screw tightening.

Specifically, defect determination apparatus 100 generates a trained model by preliminarily performing unsupervised learning of at least one of the waveforms of the torque and the rotation speed generated in motor 30 during past screw tightening that has been normally completed. Note that the unsupervised learning is unsupervised machine learning to generate a trained model through learning of training data of a good product. The trained model generated by unsupervised learning is capable of determining whether the identification target is a good product or a defective product. Defect determination apparatus 100 applies to the generated trained model at least one of the received waveforms of the torque and the rotation speed of motor 30 to determine whether the screw tightening with screw tightening apparatus 10 has been normally completed with no difference from the features of normal screw tightening. Defect determination apparatus 100 transmits the defective determination result to main control apparatus 70.

Next, the torque waveform generated in motor 30 will be described.

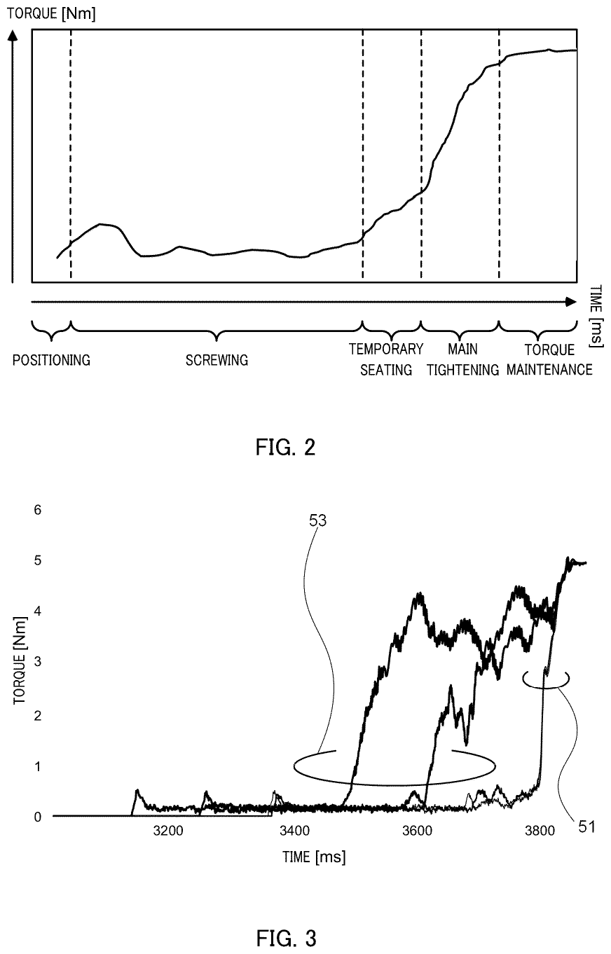

FIG. 2 is a diagram illustrating an example of a torque waveform generated in motor 30 from the start to the end of the screw tightening with screw tightening apparatus 10 according to Embodiment 1. In the example illustrated in FIG. 2, the vertical axis represents torque, and the horizontal axis represents time. Further, the torque waveform illustrated in FIG. 2 is a waveform of a normal system that has been normally completed with no defect in the screw tightening.

As illustrated in FIG. 2, the screw tightening with screw tightening apparatus 10 includes five steps: positioning, screwing, temporary seating, main tightening, and torque maintenance.

The positioning is a step of moving driver bit 20 such that screw 5 attracted and held at driver bit 20 is positioned directly above screw hole 2. In the positioning step, screw 5 is in a state where it is attracted and held at driver bit 20, and the tightening into screw hole 2 is not performed. For this reason, the torque is maintained at a relatively low value.

The screwing is a step in which driver bit 20 is moved straight downward while being rotated, and attracted and held screw 5 is screwed into screw hole 2. In the screwing step, screw 5 is in a state of being screwed into screw hole 2, which is a female screw, and the tightening to screw hole 2 is not performed. For this reason, the torque is maintained at a relatively low value.

The temporary seating is a state in which the seating surface of the screw head of screw 5 is in contact with work 1. The temporary seating is a stage in which the seating surface of screw 5 comes into contact with work 1 and the tightening of screw 5 into screw hole 2 is started. For this reason, the torque starts to increase from a relatively low value.

The main tightening is a step of further tightening screw 5 from the temporary seating. In the main tightening step, the friction generated between the seat surface of screw 5 and work 1 or between screw 5 and screw hole 2 increases when screw 5 is tightened into screw hole 2. For this reason, a torque that exceeds this friction is used, and the value of the torque increases rapidly.

The torque maintenance is a step of maintaining the torque at the completion of the main tightening for a certain time after the completion of the main tightening. For this reason, the torque is maintained at a relatively high value. Note that although not illustrated, when the torque maintenance is completed, the torque is released and rapidly reduced accordingly.

In this manner, the torque waveform in the screw tightening with screw tightening apparatus 10 reflects the characteristics of each step of the screw tightening. As such, in the screw tightening with screw tightening apparatus 10, there is an ideal torque waveform for the screw tightening flow. Note that the time and the torque required for screw tightening vary depending on the size of the screw, such as the length and thickness of the screw, and thus, an ideal torque waveform exists for each size of the screw. For this reason, the torque waveform of a case where the screw tightening of a screw of a certain size is normally completed is a torque waveform of a normal system close to an ideal torque waveform for this size. On the other hand, when there is some defect in the screw tightening, the torque waveform reflects that defect, as a torque waveform of an abnormal system deviating from the torque waveform of the normal system.

FIG. 3 is a diagram illustrating a comparison example between a torque waveform of a normal system and a torque waveform of an abnormal system by screw tightening apparatus 10 of Embodiment 1. Each waveform data for the torque illustrated in FIG. 3 is obtained when a screw with the same size is tightened by screw tightening apparatus 10. Note that as in the example illustrated in FIG. 2, the vertical axis represents torque, and the horizontal axis represents time.

In the example illustrated in FIG. 3, each waveform in the group enclosed by reference numeral 51 corresponds to a torque waveform of the normal system, and the two waveforms enclosed by reference numeral 53 correspond to waveforms of torque of the abnormal system. Note that the torque waveforms of the abnormal system are all waveforms generated when the foreign object biting has occurred as a defect. Foreign object biting is a defect in which a screw is fastened to a fastening target with a foreign object such as dust sandwiched therebetween. In the case of foreign object biting, dust or the like is sandwiched between the work and the seat surface of the screw head of the screw, resulting in a shorter time until temporarily seating compared to when the screw tightening is normally completed. For this reason, as illustrated in FIG. 3, in a case where foreign object biting occurs, the torque waveform rises earlier than in the normal system, and becomes the torque waveform of the abnormal system deviating from the torque waveform of the normal system.

In this manner, the torque waveform of the abnormal system tends to be a waveform deviating from the torque waveform of the normal system. For this reason, the defect determination apparatus 100 of Embodiment 1 generates a trained model through unsupervised learning of the torque waveform of the normal system, and uses the generated trained model to determine whether the screw tightening by the screw tightening apparatus 10 has been normally completed with no difference from the features of normal screw tightening.

Next, the configuration of defect determination apparatus 100 will be described.

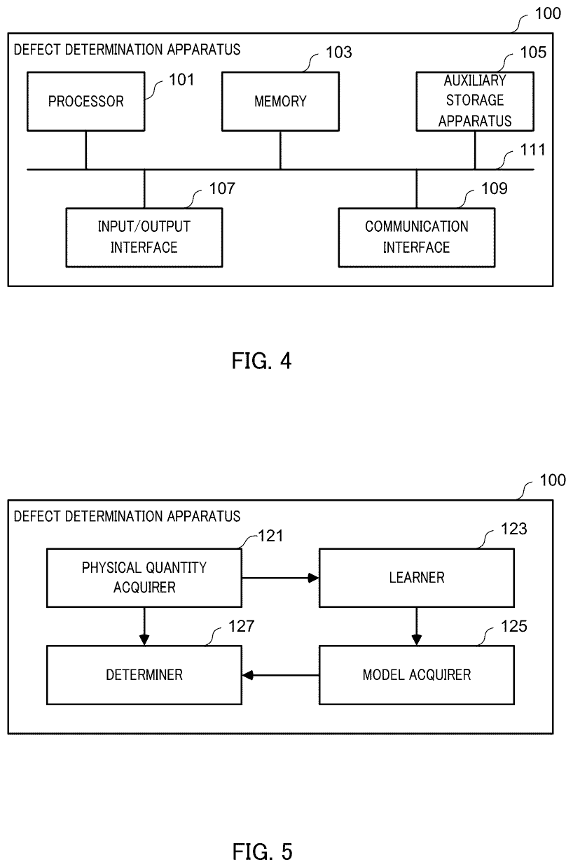

FIG. 4 is a block diagram illustrating an example of a hardware configuration of defect determination apparatus 100 according to Embodiment 1. As illustrated in FIG. 4, defect determination apparatus 100 includes processor 101, memory 103, auxiliary storage apparatus 105, input/output interface 107, communication interface 109, and various buses 111.

Processor 101, memory 103, auxiliary storage apparatus 105, input/output interface 107, and communication interface 109 are connected to each other via various buses 111. Thus, Embodiment 1 describes a case where defect determination apparatus 100 is an existing hardware configuration using an existing computer as an example, but this is not limitative. As described above, defect determination apparatus 100 may be realized by a PLC, and may be a dedicated hardware configuration.

Processor 101 controls the overall operation of defect determination apparatus 100. Examples of processor 101 include, for example, a central processing unit (CPU), but are not limited thereto. The number of CPUs is not limited as long as one or more CPUs are provided, and the CPU may be a single core or a multi-core.

Examples of memory 103 include, for example, a read only memory (ROM) and a random access memory (RAM), but are not limited thereto. ROM stores various programs, such as a program for controlling defect determination apparatus 100 and a program for machine learning. RAM is used as a work area when processor 101 performs various controls based on the program stored in ROM.

Auxiliary storage apparatus 105 stores the various programs and data for machine learning described above. Note that the various programs described above may be stored in at least one of memory 103 or auxiliary storage apparatus 105. Auxiliary storage apparatus 105 may be, for example, at least any of a magnetic, electrical, or optically storable existing storage apparatus such as a hard disk drive (HDD), a solid state drive (SSD), and a digital versatile disc (DVD), but is not limited thereto. Auxiliary storage apparatus 105 may be built into defect determination apparatus 100 or may be externally attached to defect determination apparatus 100 via an interface such as a Universal Serial Bus (USB). Further, auxiliary storage apparatus 105 may be a Network Attached Storage (NAS) connected via a network such as a Local Area Network (LAN) or a Wide Area Network (WAN).

Input/output interface 107 is an interface for various input apparatuses and various display apparatuses used in machine learning and defect determination with defect determination apparatus 100. Various input apparatuses include, for example, a keyboard, a mouse, and a touch panel, but are not limited thereto. Further, various display apparatuses include, for example, a liquid crystal display, an organic electro-luminescence (EL) display, and a touch panel display, but are not limited thereto.

Communication interface 109 may be, for example, a communication interface for a wired LAN or a wireless communication interface for a wireless LAN, but is not limited thereto. Communication interface 109 may be used when acquiring the various programs and data for machine learning described above from the outside, or may be used when outputting the defect determination result by defect determination apparatus 100 to the outside.

FIG. 5 is a block diagram illustrating an example of a functional configuration of defect determination apparatus 100 according to Embodiment 1. As illustrated in FIG. 5, defect determination apparatus 100 includes physical quantity acquirer 121, learner 123, model acquirer 125, and determiner 127. Physical quantity acquirer 121, learner 123, model acquirer 125, and determiner 127 can be realized by, for example, processor 101 and memory 103 described in FIG. 4.

For example, processor 101 reads a program for machine learning stored in memory 103 (ROM) or auxiliary storage apparatus 105, or acquired from the outside via a network through communication interface 109, and deploys the program in memory 103 (RAM). Processor 101 executes various processes according to the deployed program, thereby realizing each of the above-described functional units as software.

First, the functions of physical quantity acquirer 121 and learner 123 during the unsupervised learning performed by defect determination apparatus 100 will be described. Note that the unsupervised learning is performed in advance, before the defect determination (described later) is carried out.

Physical quantity acquirer 121 acquires the physical quantity generated in the power source when the screw tightening is normally completed. Note that physical quantity acquirer 121 acquires the physical quantities of screw tightening of n (n>2) times that have been normally completed. Further, it is assumed that screws of the same size are used for the screw tightening of n times. The physical quantity is at least any of a waveform of a rotation speed and a torque waveform of a power source. Embodiment 1 describes a case where the power source is motor 30 and the physical quantity is the torque waveform of motor 30 as an example, but this is not limitative.

Learner 123 performs the unsupervised learning of the physical quantity acquired by physical quantity acquirer 121 to generate a first trained model. The first trained model is a trained model that, with a physical quantity generated in the power source during a new screw tightening as an input, outputs whether the new screw tightening has been normally completed with no difference from the features of normal screw tightening.

In Embodiment 1, learner 123 performs the unsupervised learning of the torque waveforms of the n times acquired by physical quantity acquirer 121 to generate the first trained model. The torque waveforms of the n times are each a torque waveform of a normal system of the case where the screw tightening is normally completed. For example, the first trained model in Embodiment 1 is a trained model that, with the torque waveform generated in motor 30 during a new screw tightening as an input, outputs whether the new screw tightening has been normally completed with no difference from the features of normal screw tightening.

Embodiment 1 describes a k-nearest neighbor algorithm (knn) as an example of a machine learning method for unsupervised learning, but this is not limitative. Other machine learning methods for unsupervised learning include, for example, One Class Support Vector Machine (SVM) and Local Outlier Factor (LOF), but are not limited thereto.

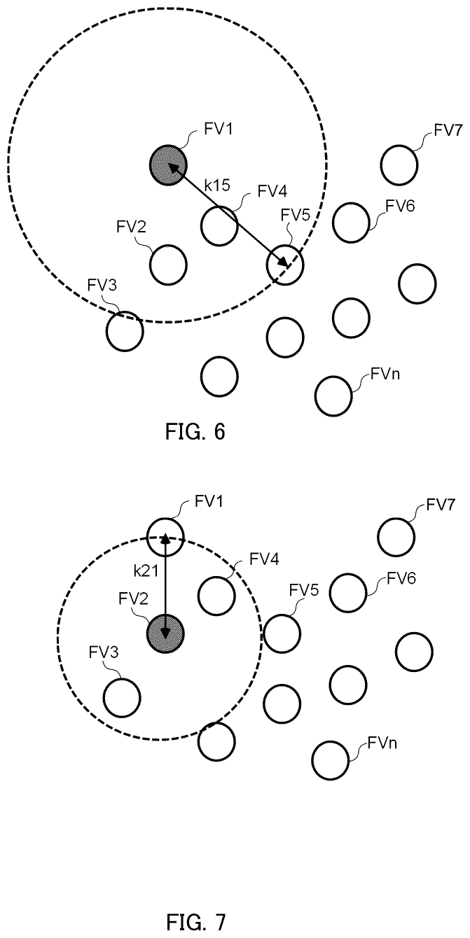

FIGS. 6 and 7 are explanatory diagrams illustrating an example of an unsupervised learning method by learner 123 in Embodiment 1. Note that FIGS. 6 and 7 are explanatory diagrams of an unsupervised learning method using the k-nearest neighbor algorithm as described above. In the examples illustrated in FIGS. 6 and 7, feature quantities FV1 to FVn of the torque waveforms of the n times, which are the torque waveforms of the normal system described above, are represented in a high-dimensional space. The feature quantity of the torque waveform is represented, for example, by a vector with a dimension equal to the number of samples, where each value of the torque is arranged when the torque waveform is sampled at the above-described sample interval. For example, in a case where the number of samples is m (m≥2), feature quantity FV1 is represented as FV1=(FV1₁, FV1₂ . . . , FV1ₘ), and feature quantity FVn is represented as FVn=(FVn₁, FVn₂ . . . , FVnₘ). Similarly, the dimension of the high-dimensional space is equal to a dimension of the number of samples.

In the unsupervised learning method using the k-nearest neighbor algorithm, learner 123 calculates the distance from the closest feature quantity to the k-th feature quantity for each of the n feature quantities, and sets the maximum distance among the calculated n distances as the threshold value for the defect determination. Embodiment 1 describes a case where k=3 as an example, but this is not limitative. Further, the distance may be a Euclidean distance, but is not limited thereto. For example, in a case where x=(x₁, x₂ . . . , x_{L}) and y=(y₁, y₂ . . . , y_{L}), the Euclidean distance between x and y is represented by Equation (1).

$$d ( x , y ) = \sqrt{{\sum }_{i = 1}^{L} {( {x}_{i} - {y}_{i} )}^{2}} \qquad ( 1 )$$

The example illustrated in FIG. 6 illustrates the distance calculated for feature quantity FV1. In the example illustrated in FIG. 6, the feature quantities close to feature quantity FV1 are FV4, FV2, FV5, FV3 . . . in order of proximity. For example, learner 123 identifies feature quantity FV5 as the k-th (k=3) feature quantity from the closer side, and calculates distance k15 between feature quantity FV1 and feature quantity FV5.

In the example illustrated in FIG. 7, the distance calculated for feature quantity FV2 is illustrated. In the example illustrated in FIG. 7, the feature quantities close to feature quantity FV2 are FV4, FV3, FV1 . . . in order of proximity. For example, learner 123 identifies feature quantity FV1 as the k-th (k=3) feature quantity from the closer side, and calculates distance k21 between feature quantity FV2 and feature quantity FV1.

While the description will be omitted below, learner 123 also identifies the k-th (k=3) feature quantity from the closer side for each of feature quantities FV3, FV4 . . . , FVn, and calculates the distance to the identified feature quantity. Learner 123 identifies the maximum distance from the n distances obtained for feature quantities FV1 to FVn, and sets this maximum distance as the threshold value for the defect determination. Learner 123 uses feature quantities FV1 to FVn, the value of k (k=3), and the calculated threshold value for the defect determination as the first trained model.

Next, the functions of physical quantity acquirer 121, model acquirer 125, and determiner 127 during the defect determination performed by defect determination apparatus 100 will be described. Note that the defect determination is performed after the first trained model is generated through the unsupervised learning described above.

Physical quantity acquirer 121 acquires a target physical quantity, which is a physical quantity generated in the power source during a new screw tightening. Note that the size of the screw used for the new screw tightening is assumed to be the same as the size of the screw used during the unsupervised learning. The physical quantity is at least any of a waveform of a rotation speed and a torque waveform of a power source. Embodiment 1 describes a case where the power source is motor 30 and the physical quantity is the torque waveform of motor 30 as an example as in unsupervised learning, but this is not limitative.

Model acquirer 125 acquires a first trained model obtained through unsupervised learning of a physical quantity generated in the power source during a past screw tightening that has been normally completed. In Embodiment 1, model acquirer 125 acquires the first trained model generated by learner 123.

Determiner 127 applies the target physical quantity acquired by physical quantity acquirer 121 to the first trained model acquired by model acquirer 125, and determines whether the new screw tightening has been normally completed with no difference from the features of normal screw tightening. Determiner 127 outputs the defect determination result to main control apparatus 70. Note that determiner 127 may output the defect determination result to a display apparatus via input/output interface 107, or may transmit the defect determination result to the outside via communication interface 109.

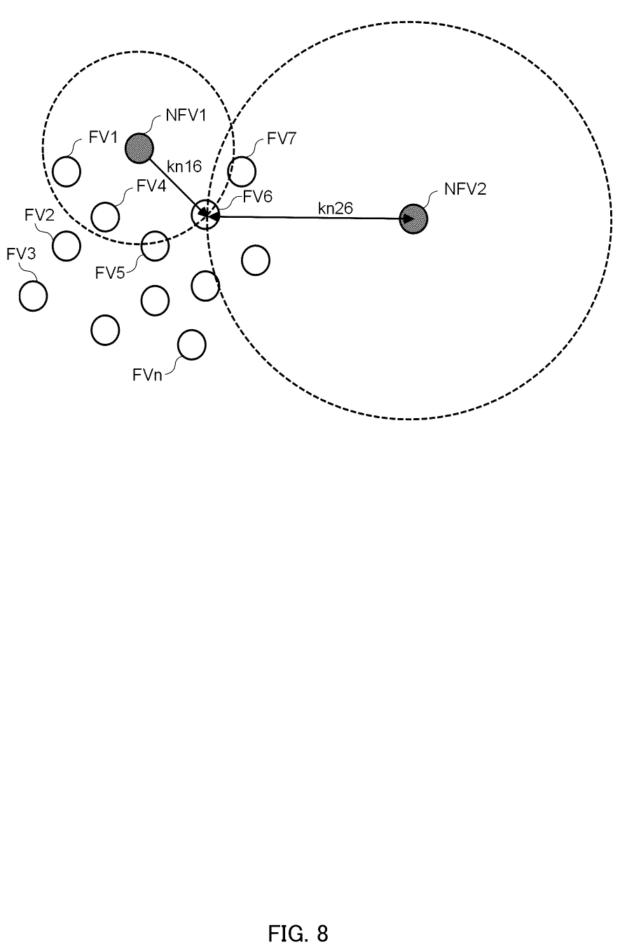

FIG. 8 is an explanatory diagram illustrating an example of a defect determination method using a first trained model by determiner 127 according to Embodiment 1. In the example illustrated in FIG. 8, the above-described feature quantities FV1 to FVn are disposed in a high-dimensional space. Further, feature quantities NFV1 and NFV2 of the torque waveform acquired by physical quantity acquirer 121 as the target physical quantity are also disposed in the high-dimensional space. Note that feature quantities NFV1 and NFV2 of the torque waveform acquired as the target physical quantity are each represented by a vector with a dimension equal to the number of samples, where each value of the torque is arranged when the torque waveform is sampled at the above-described sample interval, similarly to feature quantities FV1 to FVn.

In the defect determination method using the first trained model, determiner 127 calculates the distance to the k-th (k=3) feature quantity from the closer side with respect to the feature quantity acquired as the target physical quantity, as in the unsupervised learning. As the distance, the Euclidean distance is exemplified as in the unsupervised learning, but the present disclosure is not limited thereto. Determiner 127 compares the calculated distance with the threshold value for the defect determination obtained by learner 123. In a case where the calculated distance is less than the threshold value for the defective determination, determiner 127 determines that the new screw tightening has been normally completed with no difference from the features of normal screw tightening. On the other hand, when the calculated distance is equal to or greater than the threshold value for the defect determination, determiner 127 determines that the new screw tightening corresponds to some kind of defect. Note that “the new screw tightening corresponds to some kind of defect” means a state in which the feature of the target physical quantity in the new screw tightening is different from the feature of the target physical quantity in the past screw tightening that has been normally completed, a state in which the feature of the new screw tightening is different from the feature of the past screw tightening that has been normally completed, or a state in which the new screw tightening is different from the feature of the normal screw tightening.

In the example illustrated in FIG. 8, the distance calculated for feature quantity NFV1 is illustrated. In the example illustrated in FIG. 8, the feature quantities close to feature quantity NFV1 are FV1, FV4, FV6, FV5 . . . in order of proximity. For example, determiner 127 identifies feature quantity FV6 as the k-th (k=3) feature quantity from the closer side, and calculates distance kn16 between feature quantity NFV1 and feature quantity FV6. Determiner 127 compares the calculated distance kn16 with a threshold value for the defect determination. Here, the calculated distance kn16 is assumed to be less than the threshold value for the defect determination. Thus, determiner 127 determines that the new screw tightening for which feature quantity NFV1 has been obtained has been normally completed with no difference from the features of normal screw tightening.

Further, the example illustrated in FIG. 8 also illustrates the distance calculated for feature quantity NFV2. In the example illustrated in FIG. 8, the k-th (k=3) feature from the closer side with respect to the feature NFV2 is feature quantity FV6. For this reason, determiner 127 calculates distance kn26 between feature quantity NFV2 and feature quantity FV6, and compares the calculated distance kn26 with the threshold value for the defect determination. Here, the calculated distance kn26 is assumed to be equal to or greater than the threshold value for the defect determination. For this reason, determiner 127 determines that the new screw tightening for which feature quantity NFV2 has been obtained corresponds to some kind of defect.

Next, the processing flow of screw tightening apparatus 10 will be described.

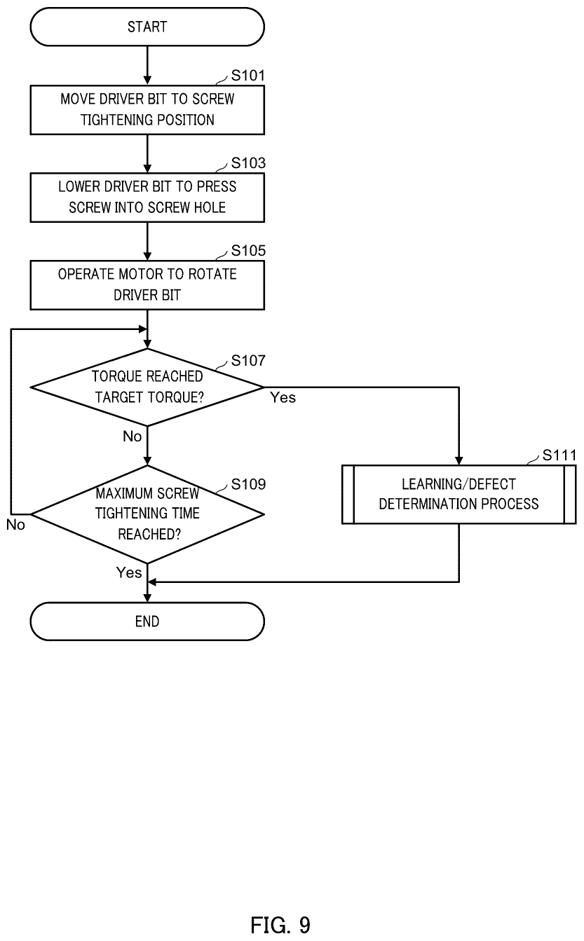

FIG. 9 is a flowchart illustrating an example of the screw tightening process by screw tightening apparatus 10 according to Embodiment 1.

First, main control apparatus 70 moves driver bit 20 to the screw tightening position such that screw 5 attracted and held at driver bit 20 is positioned directly above screw hole 2 (step S101).

Next, main control apparatus 70 lowers driver bit 20 and presses attracted and held screw 5 into screw hole 2 (step S103).

Next, main control apparatus 70 operates motor 30 to rotate driver bit 20 (step S105).

Note that in steps S103 to S105, main control apparatus 70 may operate motor 30 and lower driver bit 20 while rotating driver bit 20, thereby inserting attracted and held screw 5 into screw hole 2.

Next, main control apparatus 70 determines whether the torque generated by motor 30 has reached the target torque (step S107).

In a case where the target torque is not reached (No in step S107), main control apparatus 70 determines whether the maximum screw tightening time has been reached (step S109).

In a case where the maximum screw tightening time has not been reached (No in step S109), the process returns to step S107. In a case where the maximum screw tightening time is reached (Yes in step S109), the process ends, assuming that some defect has occurred and the screw tightening has not been normally completed.

In a case where the target torque is reached in step S107 (Yes in step S107), defect determination apparatus 100 performs the learning/defect determination process (step S111).

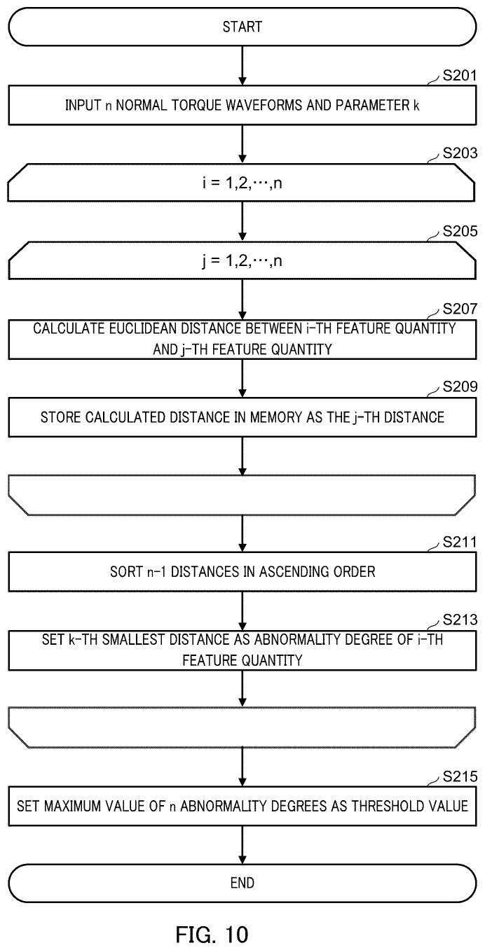

FIG. 10 is a flowchart illustrating an example of a learning (unsupervised learning) process in defect determination apparatus 100 of Embodiment 1. Note that the process illustrated in FIG. 10 is performed in step S111 of FIG. 9 when the n torque waveforms are collected in a case where the screw tightening process illustrated in FIG. 9 is performed for the purpose of collecting the torque waveform of screw tightening that has been normally completed for unsupervised learning. Note that in a case where n torque waveforms of the screw tightening that has been normally completed are prepared in advance, the process is performed independently of the process illustrated in FIG. 9.

First, physical quantity acquirer 121 inputs the n normal torque waveforms and parameter k (step S201).

Subsequently, learner 123 sets the value of i to 1 (step S203) and sets the value of j to 1 (step S205).

Subsequently, learner 123 calculates the Euclidean distance between the feature quantity of the i-th torque waveform and the feature quantity of the j-th waveform torque (step S207), and stores the calculated distance in the memory as the j-th distance (step S209). Learner 123 repeats the process in steps S205 to S209 until the process in step S209 of a case where the value of j is n is completed. Note that in a case where i=j, learner 123 skips the process in S207 to S209.

Subsequently, learner 123 sorts the n−1 distances stored in the memory in ascending order (step S211), and sets the k-th smallest distance as the abnormality degree of the feature quantity of the i-th torque waveform (step S213). Learner 123 repeats the process in steps S203 to S213 until the process in step S213 of a case where the value of i is n is completed.

Subsequently, learner 123 sets the maximum value of the n abnormality degrees to the threshold value for the defect determination (step S215).

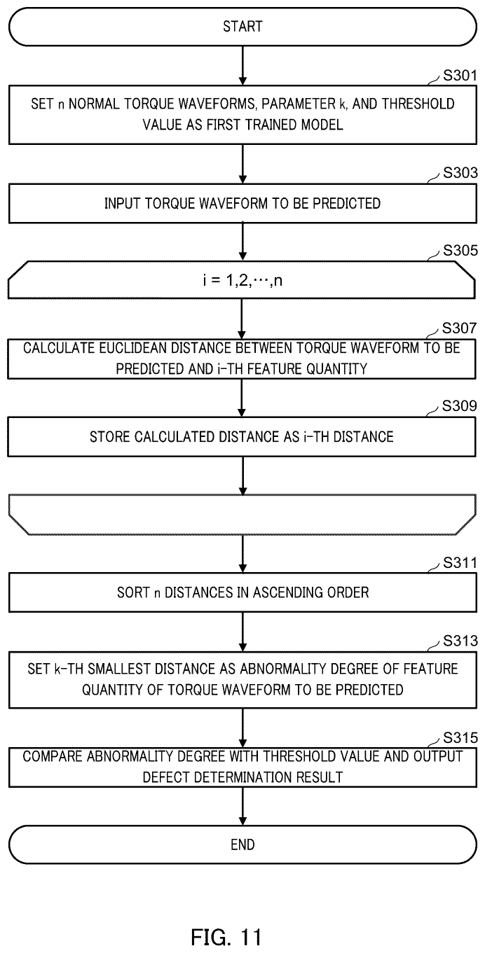

FIG. 11 is a flowchart illustrating an example of the defect determination process in defect determination apparatus 100 according to Embodiment 1. Note that the process illustrated in FIG. 11 is performed in step S111 of FIG. 9 in a case where the screw tightening process illustrated in FIG. 9 is not performed for the purpose of collecting the torque waveform of screw tightening that has been normally completed for unsupervised learning.

First, model acquirer 125 sets n normal torque waveforms, parameter k, and a threshold value for the defect determination as a first trained model (step S301).

Subsequently, physical quantity acquirer 121 inputs the torque waveform to be predicted as the target physical quantity (step S303).

Subsequently, determiner 127 sets the value of i to 1 (step S305).

Subsequently, determiner 127 calculates the Euclidean distance between the feature quantity of the torque waveform to be predicted and the feature quantity of the i-th waveform torque (step S307), and stores the calculated distance in the memory as the i-th distance (step S309). Determiner 127 repeats the process in steps S305 to S309 until the process in step S309 of a case where the value of i is n is completed.

Subsequently, determiner 127 sorts the n distances stored in the memory in ascending order (step S311), and sets the k-th smallest distance as the abnormality degree of the feature quantity of the torque waveform to be predicted (step S313).

Subsequently, determiner 127 compares the set abnormality degree with the threshold value for the defect determination and outputs the defect determination result (step S315).

As described above, in Embodiment 1, attention is paid to the tendency of the torque waveform of the abnormal system to deviate from the torque waveform of the normal system, and the defect determination apparatus 100 generates a trained model through unsupervised learning of the torque waveform of the normal system. Defect determination apparatus 100 uses the generated trained model to determine whether the screw tightening by the screw tightening apparatus 10 has been normally completed with no difference from the features of normal screw tightening. Thus, according to Embodiment 1, it is possible to determine whether the screw tightening with screw tightening apparatus 10 has been normally completed with no difference from the features of normal screw tightening, regardless of the type of defect.

For example, since defect determination apparatus 100 of Embodiment 1 is not limited to detecting defects of a given type, defect determination apparatus 100 can determine whether the screw tightening has been normally completed for various defects. For example, according to Embodiment 1, it is possible to perform determination not only for defects with a high occurrence frequency such as screw floating, cam-out, and foreign object biting, but also for defects with a low occurrence frequency such as female screw foreign object, screw stripping, screw breakage, screw mistake, free rotation, no screw, double tightening, galling (seizure), and bolt elongation.

Note that screw floating is a defect in which a screw is fastened to a fastening target in a state of being inserted obliquely with respect to a screw hole. The cam-out is a defect in which the distal end of the driver bit floats up and comes out of the screw hole. Foreign object biting is a defect in which a screw is fastened to a fastening target with a foreign object such as dust sandwiched therebetween. The female screw foreign object is a defect in which a screw is fastened to a fastening target with dust or the like sandwiched in a screw hole. The screw stripping is a defect in which the screw thread is crushed. The screw breakage is a defect in which the screw breaks. The screw mistake is a defect in which a screw with a dimension or shape different from the specification is used for tightening. The free rotation is a defect in which a screw is rotated without being inserted into a screw hole. The no screw refers to a defect in which tightening to a screw hole is performed in a state where there is no screw. The double tightening is a defect in which a screw that has already been tightened is tightened again. The galling (seizure) is a defect in which a screw is seized. The bolt elongation is a defect in which the screw stretches.

Further, according to Embodiment 1, it is possible to determine whether the screw tightening has been normally completed even in a case where unintended defects occur.

### Embodiment 2

In Embodiment 2, an example of classifying a defect in a screw tightening in which the defect has occurred will be described. Hereinafter, differences from Embodiment 1 will be mainly described, and components having the same functions as those in Embodiment 1 will be denoted by the same names and reference numerals as those in Embodiment 1, and the description thereof will be omitted.

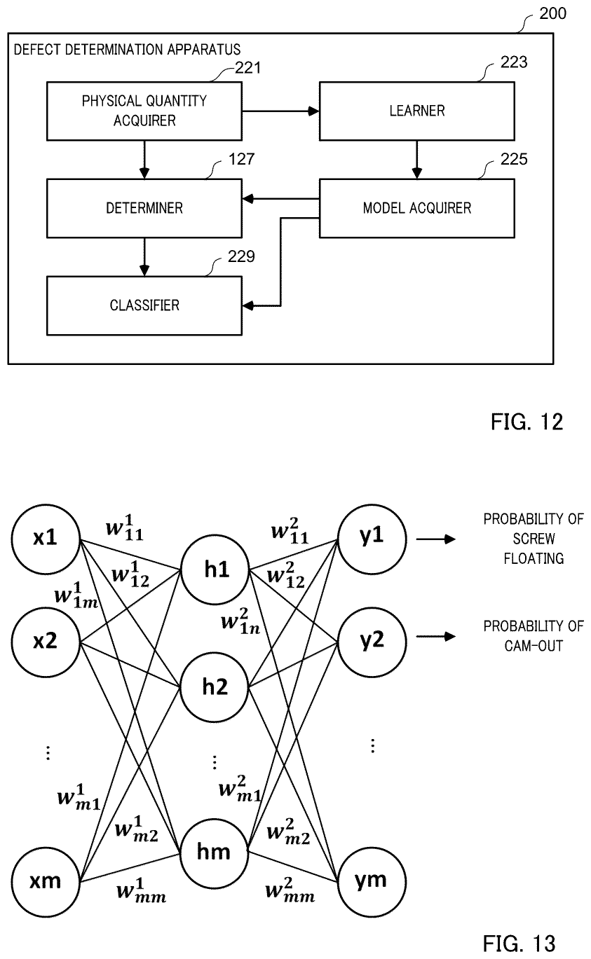

FIG. 12 is a block diagram illustrating an example of a functional configuration of defect determination apparatus 200 according to Embodiment 2. As illustrated in FIG. 12, compared to defect determination apparatus 100 of Embodiment 1, defect determination apparatus 200 differs in that classifier 229 is provided, and further differs in physical quantity acquirer 221, learner 223, and model acquirer 225.

First, the functions of physical quantity acquirer 221 and learner 223 during the unsupervised learning performed by defect determination apparatus 200 will be described. In the defect determination apparatus 200 of Embodiment 2, a second trained model for defect classification is further trained.

Physical quantity acquirer 221 further acquires the physical quantity generated in the power source during the abnormality in the screw tightening. Note that physical quantity acquirer 221 acquires the physical quantity of the screw tightening of in which an abnormality has occurred. Further, it is assumed that screws with the same size are used for the screw tightening of the s-times. The physical quantity is at least any of a waveform of a rotation speed and a torque waveform of a power source. Embodiment 2 also describes a case where the power source is motor 30 and the physical quantity is the torque waveform of motor 30 as an example, but this is not limitative.

Learner 223 performs learning of the physical quantity acquired by physical quantity acquirer 221 to generate a second trained model. The second trained model is a trained model that, with a physical quantity generated in the power source during a new screw tightening as an input, outputs a defect classification result for a new screw tightening.

In Embodiment 2, learner 223 performs learning of the torque waveforms of s-times acquired by physical quantity acquirer 221 to generate the second trained model. The torque waveforms of s-times are each a torque waveform of the abnormal system in which an abnormality has occurred in the screw tightening. For example, the second trained model is a trained model that, with the torque waveform generated in motor 30 during a new screw tightening as an input, outputs a classification result indicating which defect corresponds to the new screw tightening.

In Embodiment 2, a neural network is described as an example of the machine learning method for the second trained model, but this is not limitative. Other machine learning methods include, for example, Multiclass Support Vector Machine (SVM), but are not limited thereto.

FIG. 13 is an explanatory diagram illustrating an example of a learning method for a second trained model with learner 223 according to Embodiment 2. Note that FIG. 13 is a diagram illustrating a learning method using a neural network as described above. In the example illustrated in FIG. 13, the neural network is a three-layer neural network including input layer neurons (x1, x2 . . . , xm), intermediate layer neurons (h1, h2 . . . , hm), and output layer neurons (y1, y2 . . . , ym). Note that m is the number of samples in sampling of the torque waveform described in Embodiment 1. Note that the number of intermediate layer neurons and output layer neurons is not limited to m, and may be set to any value. For example, the number of output layer neurons is preferably the number of types of defects to be classified.

A feature quantity of the torque waveform of the abnormal system acquired by physical quantity acquirer 221 is inputted to the input layer neuron. Note that as in Embodiment 1, the feature quantity of the torque waveform is represented by a vector with a dimension equal to the number of samples, where each value of the torque is arranged when the torque waveform is sampled at the above-described sample interval. For example, in a case where the number of samples is m (m≥2), feature quantity AFV1 of the abnormal system is represented as AFV1=(AFV1₁, AFV1₂ . . . , AFV1ₘ). Values AFV1₁, AFV1₂ . . . , AFV1ₘ of feature quantity AFV1 of the abnormal system are inputted to the input layer neurons x1, x2 . . . , and xm, respectively.

Output layer neurons y1, y2 . . . , and ym each output the probability corresponding to the type of defect assigned to them. For example, in a case where screw floating is assigned to output layer neuron y1, output layer neuron y1 outputs the probability that the feature quantity of the torque waveform inputted to the input layer neuron corresponds to screw floating. Further, for example, in a case where cam-out is assigned to output layer neuron y2, output layer neuron y2 outputs the probability that the feature quantity of the torque waveform inputted to the input layer neuron corresponds to cam-out.

Intermediate layer neurons (h1, h2 . . . , hm) are values obtained by multiplying the values of input layer neurons (x1, x2 . . . , xm) by weights w¹₁₁, w¹₁₂, w¹₁ₘ . . . , w¹ₘ₁, w¹ₘ₂, w¹ₘₘ. Similarly, output layer neurons (y1, y2 . . . , ym) are values obtained by multiplying the values of intermediate layer neurons (h1, h2 . . . , hm) by weights w²₁₁, w²₁₂, w²₁ₘ . . . , w²ₘ₁, w²ₘ₂, w²ₘₘ.

However, since the output layer neurons (y1, y2 . . . , ym) output the probability of falling into the respective assigned defect types as described above, the value obtained with the initial weights results in the output value far from the correct value. For this reason, learner 223 generates, as the second trained model, a network capable of classifying a screw tightening defect by adjusting (learning) the value of each weight such that the error between the output value and the correct value is small.

Next, the functions of model acquirer 225 and classifier 229 during defect classification performed by defect determination apparatus 200 will be described. Note that the defect classification is performed after the second trained model is generated through the learning described above.

The target physical quantity acquired by physical quantity acquirer 221 and the good product determination performed by determiner 127 are the same as those in Embodiment 1.

Model acquirer 225 further acquires a second trained model that has been trained with a physical quantity generated in a power source during past screw tightening in which an abnormality has occurred as an input and with a defective classification result of screw tightening as an output. In Embodiment 2, model acquirer 225 acquires the second trained model generated by learner 223.

In a case where the new screw tightening is determined not to be normally completed by determiner 127, classifier 229 applies the target physical quantity to the second trained model acquired by model acquirer 225 to classify the defect in the new screw tightening. Classifier 229 outputs the defect classification result to main control apparatus 70. Note that classifier 229 may output the defect classification result to a display apparatus via input/output interface 107, or may transmit the defect classification result to the outside via communication interface 109.

For example, it is assumed that determiner 127 determines that the new screw tightening for which feature quantity NFV2 described in Embodiment 1 is obtained corresponds to some kind of defect. In this case, classifier 229 inputs feature quantity NFV2 into input layer neurons (x1, x2 . . . , xm) to obtain an output of a classification result indicating whether the feature quantity is classified into any of the defects from output layer neurons (y1, y2 . . . , ym).

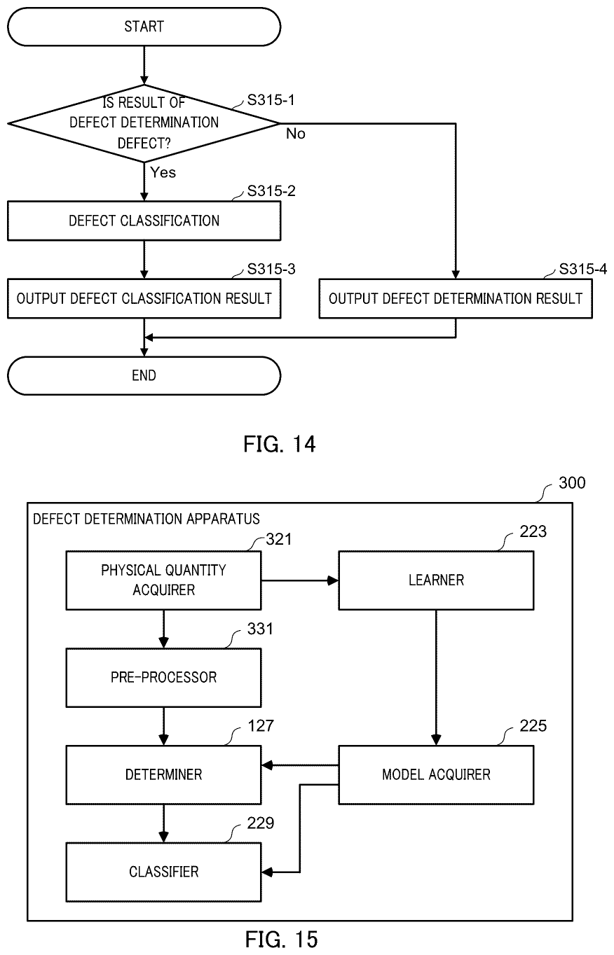

FIG. 14 is a flowchart illustrating an example of the defect classification process by defect determination apparatus 200 according to Embodiment 2. Note that the process illustrated in FIG. 14 is performed following the defect determination in step S315 of the defect determination process illustrated in FIG. 11.

In a case where the new screw tightening has not been normally completed and has been determined to be defective by determiner 127 (Yes in step S315-1), classifier 229 applies the target physical quantity to the second trained model to classify the defect in the new screw tightening (step S315-2), and outputs the defect classification result (step S315-3).

In a case where the determiner 127 determines that the new screw tightening has been normally completed (No in step S315-1), the determiner 127 outputs that the screw tightening has been normally completed as a defect determination result (step S315-4).

Note that in Embodiment 1, the process is terminated when the maximum screw tightening time is reached in step S109 of the screw tightening process illustrated in FIG. 9 (Yes in step S109). In Embodiment 2, on the other hand, the learning/defect determination process in step S111 is performed in order to classify the types of defects, even in this case.

Further, although the description in the flowchart is omitted, in a case where the screw tightening process illustrated in FIG. 9 is performed for the purpose of collecting the torque waveform of the abnormal system for learning of the defective classification, when s torque waveforms are collected, the generation process of the second trained model described in FIG. 13 is performed in step S111 in FIG. 9. Note that in a case where s torque waveforms of the abnormal system are prepared in advance, the process is performed independently of the process illustrated in FIG. 9.

As described above, in Embodiment 2, it is possible to classify the type of defect in the case where the screw tightening with screw tightening apparatus 10 corresponds to any defect.

### Modification Example 1

Note that Embodiment 2 describes a case where the defect classification is performed by the second trained model on the premise of the defect determination by the first trained model, but this is not limitative. For example, in an environment where the torque waveform of an abnormal system is prepared in advance, the defective classification apparatus may perform defective classification using the second trained model, independently.

### Modification Example 2

Further, Embodiment 2 describes an example in which the defect classification is performed by the second trained model on the premise of the defect determination by the first trained model as described above, but the defect determination may also be performed by the second trained model. In this case, the neural network may be trained using training data that includes the torque waveform of the normal system, and one output layer neuron may be added to output probability that the screw tightening has been normally completed.

### Modification Example 3

Embodiments 1 and 2 describe the torque waveform generated in motor 30 as the physical quantity as an example, but this is not limitative. The waveform of the rotation speed of motor 30 also reflects the characteristics of each step of the screw tightening, and therefore can be utilized in the same manner as the torque waveform. Note that in the case of the waveform of the rotation speed of motor 30, the rotation speed is maintained at a relatively high value until the tightening of screw 5 into screw hole 2 is started. Then, when the state of temporary seating is reached, the rotation speed begins to decrease from a relatively high value, and when the state of main tightening is reached, the rotation speed decreases sharply and is maintained at a relatively low value. Further, in the above-described Embodiments 1 and 2, the physical quantity generated in motor 30 may be a combination of a feature quantity of the torque waveform and a feature quantity of the waveform of the rotation speed.

### Embodiment 3

Embodiment 3 describes an example in which the torque waveform to be determined is subjected to pre-processing in order to handle various screw sizes. Hereinafter, differences from Embodiment 2 will be mainly described, and components having the same functions as those in Embodiment 2 will be denoted by the same names and reference numerals as those in Embodiment 2, and the description thereof will be omitted.

FIG. 15 is a block diagram illustrating an example of a functional configuration of defect determination apparatus 300 according to Embodiment 3. As illustrated in FIG. 15, compared to defect determination apparatus 200 of Embodiment 2, defect determination apparatus 300 differs in that pre-processor 331 is provided, and further differs in physical quantity acquirer 321.

Physical quantity acquirer 321 acquires a target physical quantity, which is a physical quantity generated in the power source during a new screw tightening. In Embodiment 3, the size of the screw used for the new screw tightening is different from the size of the screw used for the learning. The size of the screw is at least one of the length or the thickness of the screw. Note that the size of the screw used for the learning (the screw used in past screw tightening) is assumed to be a screw of a predetermined size.

In a case where the screw used for the new screw tightening is not a predetermined size, pre-processor 331 normalizes at least a part of the target physical quantity such that the target physical quantity matches the physical quantity generated in the power source during the past screw tightening. At least a part of the target physical quantity is, for example, a physical quantity from the positioning of the screw to the temporary seating.

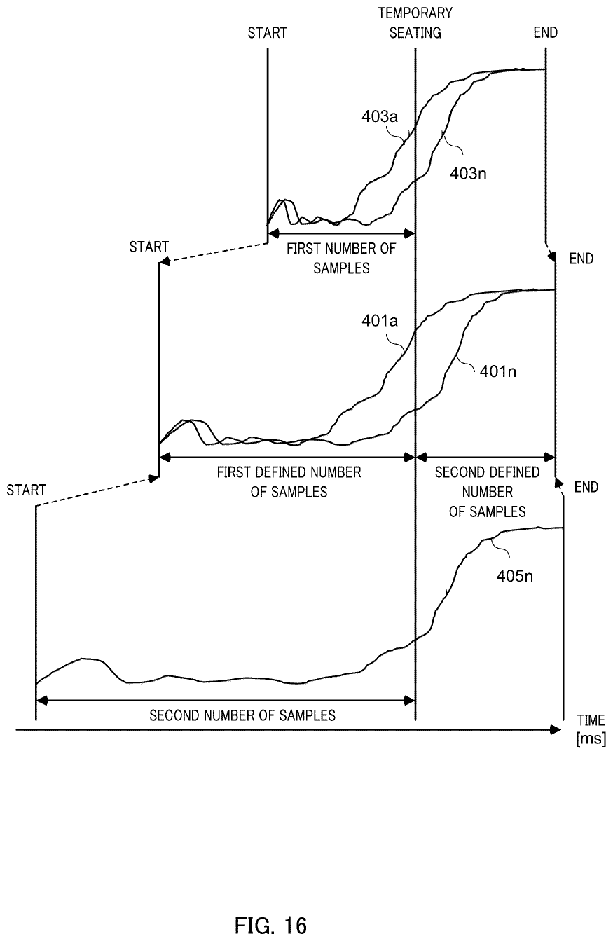

FIG. 16 is an explanatory diagram illustrating an example of a pre-processing method for a target physical quantity by pre-processor 331 according to Embodiment 3. In the example illustrated in FIG. 16, an example of a torque waveform generated in motor 30 from the start to the end of the screw tightening with screw tightening apparatus 10 is illustrated. Waveforms 401n and 401a illustrate the torque waveform during screw tightening with a screw of a predetermined length. Waveform 401n is a torque waveform of the normal system, and waveform 401a is a torque waveform of the abnormal system. In the example illustrated in FIG. 16, it is assumed that the first trained model is trained using waveform 401n and the like, and the second trained model is trained using waveform 401a and the like.

Further, waveforms 403n and 403a illustrate the torque waveform during screw tightening with a screw shorter than a screw of a predetermined length. Waveform 403n is a torque waveform of the normal system, and waveform 403a is a torque waveform of the abnormal system. Further, waveform 405n illustrates the torque waveform during screw tightening with a screw longer than a screw of a predetermined length. In Embodiment 3, the waveforms are normalized such that the torque waveforms, such as waveforms 403n, 403a, and 405n, during screw tightening with screws of lengths different from the screws of predetermined lengths can be handled in the defect determination and the defect classification as the target physical quantity.

Here, the maximum value of the torque does not change depending on the length of the screw, but the time from the start (positioning) of the screw tightening to the temporary seating changes in proportion to the length of the screw. For this reason, as illustrated in FIG. 16, even in a case where the lengths of the screws are different, the waveform shape from the temporary seating to the end of the screw tightening (torque maintenance) does not change significantly, but the waveform shape from the start of the screw tightening to the temporary seating shrinks or stretches in the time direction depending on the size of the screw.

For this reason, in Embodiment 3, the torque waveform during screw tightening with a screw shorter than a screw of a predetermined length, such as waveforms 403n and 403a, is normalized such that the waveform from the start of screw tightening to the temporary seating becomes longer in the time direction. Specifically, the first number of samples, which is the number of samples from the start of the screw tightening to the temporary seating in waveforms 403n and 403a, is normalized to be the defined number of samples, which is the number of samples from the start of the screw tightening to the temporary seating in waveforms 401n and 401a.

Similarly, the torque waveform during screw tightening with a screw longer than a screw of a predetermined length, such as waveform 405n, is normalized such that the waveform from the start of screw tightening to the temporary seating is shortened in the time direction. Specifically, the second number of samples, which is the number of samples from the start of the screw tightening to the temporary seating in waveform 405n, is normalized to be the defined number of samples from the start of the screw tightening to the temporary seating in waveforms 401n and 401a.

Thus, even in a case where a torque waveform of a screw having a length different from a predetermined length is input as the target physical quantity, it is possible to perform defect determination and defect classification.

Note that for the waveform from the temporary seating to the end of the screw tightening, in a case where the difference in the number of samples is on the order of an error, normalization in the time direction may not be performed.

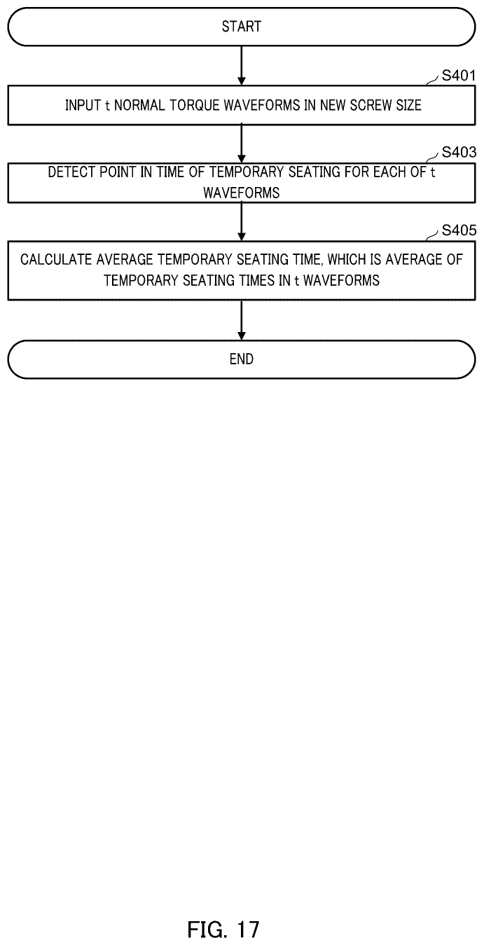

FIG. 17 is a flowchart illustrating an example of a pre-preparation process for performing pre-processing in defect determination apparatus 300 according to Embodiment 3.

First, physical quantity acquirer 321 inputs t normal torque waveforms during screw tightening with a screw of a new length, which is different from a screw of a predetermined length, in order to handle the screw of the new length (step S401). Subsequently, pre-processor 331 detects the point in time of the temporary seating for each of the inputted t normal torque waveforms (step S403). Subsequently, for each of the inputted t normal torque waveforms, pre-processor 331 calculates an average temporary seating time, which is the average of the temporary seating times from the start (positioning) of the screw tightening to the temporary seating (step S405).

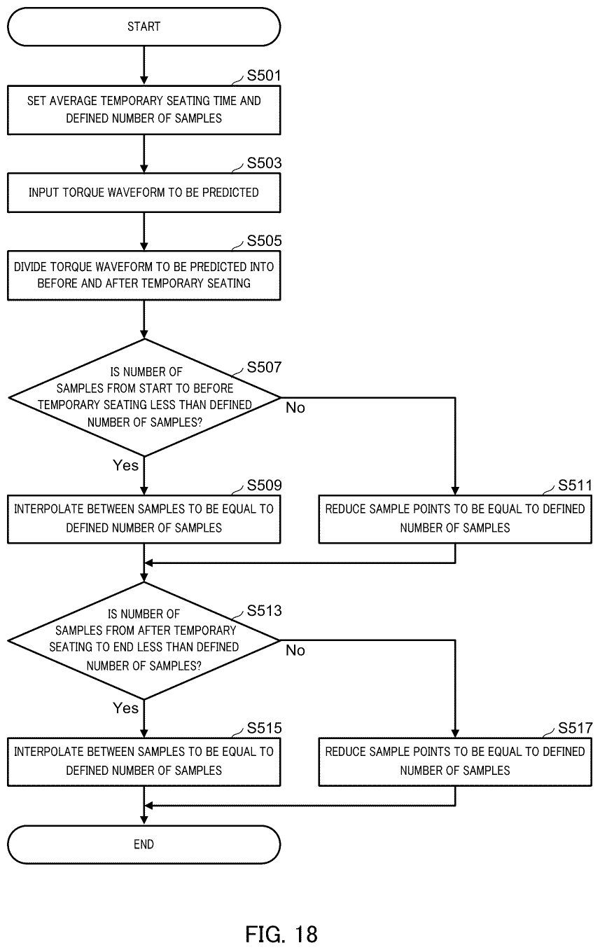

FIG. 18 is a flowchart illustrating an example of the pre-processing in defect determination apparatus 300 according to Embodiment 3.

First, pre-processor 331 sets the average temporary seating time calculated in the pre-preparation process and the defined number of samples from the start (positioning) of the screw tightening to the temporary seating during the screw tightening with a screw of a predetermined length (step S501).

Subsequently, physical quantity acquirer 321 inputs the torque waveform at the time of new screw tightening with a screw of a new length as the torque waveform to be predicted (step S503).

Subsequently, pre-processor 331 divides, by using the average temporary seating time, the inputted torque waveform to be predicted into a waveform from the start (positioning) of the screw tightening to before the temporary seating and a waveform from after the temporary seating to the end (torque maintenance) of the screw tightening (step S505).

Subsequently, in a case where the number of samples of the waveform from the start (positioning) of the screw tightening to before the temporary seating is less than the defined number of samples (Yes in step S507), pre-processor 331 interpolates between the samples to be equal to the defined number of samples (step S509).

On the other hand, in a case where the number of samples of the waveform from the start (positioning) of the screw tightening to before the temporary seating is larger than the defined number of samples (No in step S507), pre-processor 331 reduces the sample points such that the number of samples becomes equal to the defined number of samples (step S511).

Subsequently, in a case where the number of samples of the waveform from after the temporary seating to the end of the screw tightening (torque maintenance) is smaller than the defined number of samples (Yes in step S513), pre-processor 331 interpolates between the samples such that the number of samples becomes equal to the defined number of samples (step S515).

On the other hand, in a case where the number of samples of the waveform from the after temporary seating to the end of the screw tightening (torque maintenance) is larger than the defined number of samples (No in step S513), pre-processor 331 reduces the sample points such that the number of samples becomes equal to the defined number of samples (step S517).

As described above, in Embodiment 3, the change in the torque waveform when the length of the screw is different is different before and after the temporary seating. Therefore, the normalization is also divided into before and after the temporary seating, and the normalization is performed with respectively different degrees. Thus, according to Embodiment 3, it is possible to perform defect determination and defect classification corresponding to various screw sizes.

### Modification Example 4

Even in the above-described Embodiment 3, the torque waveform generated in motor 30 as the physical quantity has been described as an example, but the same tendency can be seen in the waveform of the rotation speed of motor 30 in a case where the length of the screw is different. For this reason, the waveform of the rotation speed of motor 30 can also be utilized in the same manner as the torque waveform.

### Modification Example 5

In the above-described Embodiment 3, the pre-process in a case where the length of the screw is different has been described, but the method described in Embodiment 3 can also be applied to a case where the thickness of the screw is different. Note that in a case where the thickness of the screw is different, the time required for the screw tightening changes for the entire screw tightening, not just until the temporary seating. Further, in a case where the thickness of the screw is different, the torque required for the entire screw tightening also changes. For this reason, in a case where the thickness of the screw is different, normalization in the time direction and normalization in the torque direction are considered.

### Program

The program executed by the defect determination apparatuses 100, 200, and 300 in each of the above-described embodiments and each of the above-described modification examples is provided by being stored in a computer-readable storage medium such as a CD-ROM, a CD-R, a memory card, a DVD, a flexible disk (FD), or the like in a file in an installable format or an executable format.

In addition, the program executed by the defect determination apparatuses 100, 200, and 300 in each of the above-described embodiments and each of the above-described modification examples may be configured to be stored on a computer connected to a network such as the Internet and to be provided by being downloaded via the network. Further, the program executed by the defect determination apparatuses 100, 200, and 300 in each of the above-described embodiments and each of the above-described modification examples may be provided or distributed via a network such as the Internet. Further, the program executed by the defect determination apparatuses 100, 200, and 300 in each of the above-described embodiments and each of the above-described modification examples may be provided by being incorporated in advance into a ROM or the like.

The program executed by the defect determination apparatuses 100, 200, and 300 in each of the above-described embodiments and each of the above-described modification examples has a module configuration for realizing each of the above-described units on a computer. In actual hardware, for example, each of the above-described units are realized on a computer by a CPU reading a learning program from an HDD into a RAM and executing the program.

As described above, according to each of the embodiments and each of the modification examples, it is possible to determine whether the screw tightening has been normally completed, regardless of the type of defect.

Note that each of the above-described embodiments and each of the above-described modification examples are merely examples of specific embodiments for carrying out the present disclosure, and the technical scope of the present disclosure is not interpreted in a limited manner by these. Accordingly, the present disclosure can be implemented in various forms without departing from the spirit or essential characteristics thereof. For example, the above-described embodiment and each of the above-described modification examples may be appropriately combined with each other in each configuration unit. Further, for example, in the above-described embodiment and each of the above-described variations, some components may be deleted from all the components.

In the above explanation, the notation “ . . . part” used for each component may be replaced by other notation such as “ . . . assembly,” “ . . . circuitry,” “ . . . device,” “ . . . unit,” or module.

The present disclosure includes the following aspects.
(1) A defect determination apparatus includes: a physical quantity acquisition circuitry which, in operation, acquires a target physical quantity, the target physical quantity being a physical quantity generated in a power source during a new screw tightening; a model acquisition circuitry which, in operation, acquires a first trained model obtained through unsupervised learning of a physical quantity generated in the power source during a past screw tightening that has been normally completed; and a determination circuitry which, in operation, determines whether the new screw tightening has been normally completed by applying the target physical quantity to the first trained model.
(2) The defect determination apparatus according to (1), in which the model acquisition circuitry further which, in operation, acquires a second trained model that has been trained with a physical quantity generated in the power source during a past screw tightening in which an abnormality has occurred as an input and with a defective classification result of screw tightening as an output; and in which the defect determination apparatus further includes a classify circuitry which, in operation, classifies a defect in the new screw tightening by applying the target physical quantity to the second trained model when the determination circuitry which, in operation, determines that the new screw tightening has not been normally completed.
(3) The defect determination apparatus according to (1), in which a screw used for the past screw tightening is a screw with a predetermined size, and in which the defect determination apparatus further includes a pre-processor circuitry which, in operation, when a screw used for the new screw tightening is not the screw with the predetermined size, by normalizing at least a part of the target physical quantity, matches the target physical quantity with the physical quantity generated in the power source during the past screw tightening.
(4) The defect determination apparatus according to (3), in which the at least the part of the target physical quantity is a physical quantity from positioning of the screw to temporary seating in the target physical quantity.
(5) The defect determination apparatus according to (1), in which the physical quantity is at least any of a torque waveform of the power source and a waveform of a rotation speed of the power source.
(6) A defect classification apparatus includes: a physical quantity acquisition circuitry which, in operation, acquires a target physical quantity, the target physical quantity being a physical quantity generated in a power source during a new screw tightening; a model acquisition circuitry which, in operation, acquires a trained model that has been trained with a physical quantity generated in the power source during a past screw tightening in which an abnormality has occurred as an input and with a defective classification result of screw tightening as an output; and a classify circuitry which, in operation, classifies a defect in the new screw tightening by applying the target physical quantity to the trained model.
(7) The defect classification apparatus according to (6), in which a screw used for the past screw tightening is a screw with a predetermined size, and in which the defect classification apparatus further includes a pre-processor circuitry which, in operation, when a screw used for the new screw tightening is not the screw with the predetermined size, by normalizing at least a part of the target physical quantity, matches the target physical quantity with the physical quantity generated in the power source during the past screw tightening.
(8) The defect classification apparatus according to (7), in which the at least the part of the target physical quantity is a physical quantity from positioning of the screw to temporary seating in the target physical quantity.
(9) The defect classification apparatus according to (6), in which the physical quantity is at least any of a torque waveform of the power source and a waveform of a rotation speed of the power source.
(10) A defect determination method includes: physical quantity acquiring, by a physical quantity acquisition circuitry, a target physical quantity, the target physical quantity being a physical quantity generated in a power source during a new screw tightening; first trained model acquiring, by a model acquisition circuitry, a first trained model obtained through unsupervised learning of a physical quantity generated in the power source during a past screw tightening that has been normally completed; and determining, by a determination circuitry, whether the new screw tightening has been normally completed by applying the target physical quantity to the first trained model.
(11) The defect determination method according to (10), further includes: a second trained model acquiring a second trained model that has been trained with a physical quantity generated in the power source during a past screw tightening in which an abnormality has occurred as an input and with a defective classification result of screw tightening as an output; and classifying a defect in the new screw tightening by applying the target physical quantity to the second trained model when it is determined that the new screw tightening has not been normally completed.
(12) The defect determination method according to (10), in which a screw used for the past screw tightening is a screw with a predetermined size, and in which the defect determination method further includes: matching the target physical quantity with the physical quantity generated in the power source during the past screw tightening by normalizing at least a part of the target physical quantity when a screw used for the new screw tightening is not the screw with the predetermined size.
(13) The defect determination method according to (12), in which the at least the part of the target physical quantity is a physical quantity from positioning of the screw to temporary seating in the target physical quantity.
(14) The defect determination method according to (10), in which the physical quantity is at least any of a torque waveform of the power source and a waveform of a rotation speed of the power source.

This application is entitled to and claims the benefit of Japanese Patent Application No. 2024-018574 filed on Feb. 9, 2024, the disclosure each of which including the specification, drawings and abstract is incorporated herein by reference in its entirety.

### REFERENCE SIGNS LIST

1 Work
2 Screw hole
5 Screw
10 Screw tightening apparatus
20 Driver bit
30 Motor
40 Stage
50 Motor driving apparatus
60 Stage driving apparatus
70 Main control apparatus
100, 200, 300 Defect determination apparatus
101 Processor
103 Memory
105 Auxiliary storage apparatus
107 Input/output interface
109 Communication interface
111 Various buses
121, 221, 321 Physical quantity acquirer
123, 223 learner
125, 225 Model acquirer
127 Determiner
229 Classifier
331 Pre-processor

1. A defect determination apparatus comprising:
a physical quantity acquisition circuitry which, in operation, acquires a target physical quantity, the target physical quantity being a physical quantity generated in a power source during a new screw tightening;
a model acquisition circuitry which, in operation, acquires a first trained model obtained through unsupervised learning of a physical quantity generated in the power source during a past screw tightening that has been normally completed; and
a determination circuitry which, in operation, determines whether the new screw tightening has been normally completed by applying the target physical quantity to the first trained model.

2. The defect determination apparatus according to claim 1,
wherein the model acquisition circuitry further which, in operation, acquires a second trained model that has been trained with a physical quantity generated in the power source during a past screw tightening in which an abnormality has occurred as an input and with a defective classification result of screw tightening as an output; and
wherein the defect determination apparatus further comprises a classify circuitry which, in operation, classifies a defect in the new screw tightening by applying the target physical quantity to the second trained model when the determination circuitry which, in operation, determines that the new screw tightening has not been normally completed.

3. The defect determination apparatus according to claim 1,
wherein a screw used for the past screw tightening is a screw with a predetermined size, and
wherein the defect determination apparatus further comprises a pre-processor circuitry which, in operation, when a screw used for the new screw tightening is not the screw with the predetermined size, by normalizing at least a part of the target physical quantity, matches the target physical quantity with the physical quantity generated in the power source during the past screw tightening.

4. The defect determination apparatus according to claim 3,
wherein the at least the part of the target physical quantity is a physical quantity from positioning of the screw to temporary seating in the target physical quantity.

5. The defect determination apparatus according to claim 1,
wherein the physical quantity is at least any of a torque waveform of the power source and a waveform of a rotation speed of the power source.

6. A defect classification apparatus comprising:
a physical quantity acquisition circuitry which, in operation, acquires a target physical quantity, the target physical quantity being a physical quantity generated in a power source during a new screw tightening;
a model acquisition circuitry which, in operation, acquires a trained model that has been trained with a physical quantity generated in the power source during a past screw tightening in which an abnormality has occurred as an input and with a defective classification result of screw tightening as an output; and
a classify circuitry which, in operation, classifies a defect in the new screw tightening by applying the target physical quantity to the trained model.

7. The defect classification apparatus according to claim 6,
wherein a screw used for the past screw tightening is a screw with a predetermined size, and
wherein the defect classification apparatus further comprises a pre-processor circuitry which, in operation, when a screw used for the new screw tightening is not the screw with the predetermined size, by normalizing at least a part of the target physical quantity, matches the target physical quantity with the physical quantity generated in the power source during the past screw tightening.

8. The defect classification apparatus according to claim 7,
wherein the at least the part of the target physical quantity is a physical quantity from positioning of the screw to temporary seating in the target physical quantity.

9. The defect classification apparatus according to claim 6,
wherein the physical quantity is at least any of a torque waveform of the power source and a waveform of a rotation speed of the power source.

10. A defect determination method comprising:
physical quantity acquiring, by a physical quantity acquisition circuitry, a target physical quantity, the target physical quantity being a physical quantity generated in a power source during a new screw tightening;
first trained model acquiring, by a model acquisition circuitry, a first trained model obtained through unsupervised learning of a physical quantity generated in the power source during a past screw tightening that has been normally completed; and
determining, by a determination circuitry, whether the new screw tightening has been normally completed by applying the target physical quantity to the first trained model.

11. The defect determination method according to claim 10, further comprises:
a second trained model acquiring a second trained model that has been trained with a physical quantity generated in the power source during a past screw tightening in which an abnormality has occurred as an input and with a defective classification result of screw tightening as an output; and
classifying a defect in the new screw tightening by applying the target physical quantity to the second trained model when it is determined that the new screw tightening has not been normally completed.

12. The defect determination method according to claim 10,
wherein a screw used for the past screw tightening is a screw with a predetermined size, and
wherein the defect determination method further comprises:
matching the target physical quantity with the physical quantity generated in the power source during the past screw tightening by normalizing at least a part of the target physical quantity when a screw used for the new screw tightening is not the screw with the predetermined size.

13. The defect determination method according to claim 12,
wherein the at least the part of the target physical quantity is a physical quantity from positioning of the screw to temporary seating in the target physical quantity.

14. The defect determination method according to claim 10,
wherein the physical quantity is at least any of a torque waveform of the power source and a waveform of a rotation speed of the power source.
